(19) United States
(12) Patent Application Publication
(10) Pub. No.: US 2023/0299323 A1
(43) Pub. Date: Sep. 21, 2023

(54) METHOD FOR PRODUCING A MEMBRANE ELECTRODE ASSEMBLY

(71) Applicant: Robert Bosch GmbH, Stuttgart (DE)

(72) Inventors: Manuel Schneiter, Boeblingen (DE); Stefan Schoenbauer, Ditzingen (DE)

(21) Appl. No.: 18/013,960

(22) PCT Filed: Jun. 18, 2021
(86) PCT No.: PCT/EP2021/066585

§ 371 Date: Dec. 30, 2022

(30) Foreign Application Priority Data
Jun. 30, 2020 (DE) 10 2020 208 179.4

(51) Int. Cl. H01M 8/1004

(52) U.S. Cl. CPC H01M 8/1004; H01M 2250/20

(57) ABSTRACT

The invention relates to a method for producing membrane electrode assemblies (MEA) for fuel cells (101), in particular in a continuous flow path process, comprising the following steps: 1) providing a band-shaped membrane material (M) in a flow path direction (D), e.g. on a roller, such that in particular the membrane material (M) can be unwound from the roller in the flow path process, 2) coating the band-shaped membrane material (M) with an active material (E), 3) cutting the coated membrane material (M) into individual membrane electrode assemblies (MEA), such that the individual membrane electrode assemblies (MEA) are formed with at least one edge region (TR), which is formed so as to be curved and/or angled when viewed in the flow path direction (D).

### BACKGROUND OF THE INVENTION

The invention relates to a method for producing membrane electrode assemblies. Further, the invention relates to a corresponding membrane electrode assembly. In addition, the invention relates to a corresponding fuel cell system as well as a corresponding vehicle, in particular a hydrogen-powered vehicle.

In modern fuel cells, it is always being attempted to optimize the proportion of a fuel cell that is used in order to generate power. Energy generation in the fuel cells in served by a membrane material with a coating made of an active material, a so-called catalyst layer, and optionally a gas diffusion layer. In order to optimize the generation of power, in some fuel cells, the surface area of the membrane material in the transition area used for media distribution is also configured for power generation. This can result in a relative gain of about 20-30% in volumetric power density. In order to exploit the costly components of the membrane material as far as possible without waste, the shape of the blanks can be adjusted, which can repeat as much as possible without gaps on the mostly band-shaped membrane material. Exemplary designs of the blanks of the membrane material are shown in the publications DE 10 2015 201 548 A1 and DE 10 2018 200 673 A1. In addition to the primary function, such as power generation, secondary functions, such as, e.g. sealing as well as media distribution (transition area with so-called ports), must be fulfilled. Compromises must always be made.

### SUMMARY OF THE INVENTION

According to a first aspect, the invention provides a method of producing membrane electrode assemblies having the features of the independent method claim. Further, according to a second aspect, the invention provides a corresponding membrane electrode assembly having the features of the independent apparatus claim. In addition, according to a third aspect, the invention provides a corresponding fuel cell system having the features of the independent apparatus claim. Furthermore, according to a fourth aspect, the invention provides a corresponding vehicle, in particular a hydrogen-powered vehicle, having the features of the further parallel independent apparatus claim. Of course, features and details described in connection with the individual aspects according to the invention also apply in connection with the other aspects according to the invention and respectively vice versa, so that with respect to the disclosure, mutual reference to the individual aspects of the invention is or can always be made.

According to the first aspect, the present invention provides: a method of producing membrane electrode assemblies for fuel cells, e.g. PEM fuel cells, in particular in a continuous flow path process, comprising the following steps:
1) providing a band-shaped membrane material in a flow path direction, e.g. on a roller, such that in particular the membrane material can be unwound from the roller in the flow path process,
1) coating the band-shaped membrane material with an active material and a gas diffusion layer, if applicable,
2) cutting the coated membrane material into individual membrane electrode assemblies such that
the individual membrane electrode assemblies are formed with at least one edge region (or transition region provided for media distribution), which is formed so as to be curved and/or angled when viewed in the flow path direction.

The steps of the method according to the invention can be performed in the specified order or in an amended order. Advantageously, the steps of the method according to the invention can be performed simultaneously and/or repetitively in order to enable a flow path process.

The idea of the invention is to provide the blanks of the coated membrane material with such edge portions that are curved or angled by the active surface of the individual membrane electrode assemblies. The edge regions can be formed in the shape of curved or bent and/or angular strips (e.g. in the form of parallelograms).

In this way, at least two significant advantages can be achieved. On the one hand, the blanks can be repeated without gaps on the band-shaped membrane material. Thus, after cutting the individual membrane electrode assemblies, there is almost no waste from the expensive active material. On the other hand, this can result in a narrow, for example trapezoidal, strip of an unused volume on one side of the individual membrane electrode assemblies. Stacking individual fuel cells into a fuel cell system can create a trapezoidal storage space (or, geometrically speaking, a straight cylinder with a trapezoidal bottom surface) in which all of the fuel cell system devices and connectors can be space-savingly arranged, such as busbars and electrical connectors. Because these devices are already needed in the fuel cell system, this increases the overall space efficiency of the system in an advantageous manner. Further, a compact rectangular housing can thereby be used in order to accommodate the fuel cell system.

In other words, the advantages according to the present invention lie at least in that the edge regions with the active surface of the coated membrane material are produced nearly 100% without waste and, at the same time, maximize the packaging possibilities of the fuel cell system.

Further, in a method for producing membrane electrode assemblies for fuel cells, the invention can provide that, in step 3), the individual membrane electrode assemblies are formed with both edge regions which are curved and/or angled when viewed in the direction of the flow path. In this way, symmetrical membrane electrode assemblies can be provided that can be easily handled when stacking fuel cells into a fuel cell system. Thus, the construction of the fuel cell system can be simplified.

Furthermore, it is conceivable in the context of the invention that the two edge regions are formed so as to be curved and/or angled in the same direction. In this way, a particularly compact fuel cell system can be provided.

Furthermore, it is conceivable within the scope of the invention that the two edge regions are formed so as to be curved and/or angled in opposite directions. In this way, a fuel cell system can be provided with a homogenized stress profile.

In addition, the invention can provide, in a method for the production of membrane electrode assemblies for fuel cells, that the two edge regions are symmetrically formed. In this way, the fuel cells with symmetric ports on both edge regions can be enabled, thereby simplifying the interconnection of the fuel cells within the fuel cell system and the media supply components.

According to the second aspect, the present invention provides: a membrane electrode assembly for a fuel cell that can be produced as described above. Using the membrane electrode assembly according to the invention, the same advantages can be achieved as described above in connection with the method according to the invention. In the present case, reference to these advantages is made in full.

According to the third aspect, the present invention provides: a fuel cell system having at least one fuel cell comprising a membrane electrode assembly that can be produced as described above. The fuel cell system according to the invention can be configured in the form of a fuel cell stack having a plurality of stacked repeat assemblies in the form of individual fuel cells, preferably PEM fuel cells. Using the fuel cell system according to the invention, the same advantages can be achieved as described above in connection with the method according to the invention. In the present case, reference to these advantages is made in full.

Further, in a fuel cell system, the invention can provide that a rectangular housing (or, geometrically speaking, a straight cylinder having a rectangular bottom surface) is provided for the at least one fuel cell. Such a housing is not only easy to produce, but also easy to handle, for example, when mounted in a vehicle. In a simple manner, a plurality of fuel cell systems can also be flexibly combined in order to form a modularly structured system of any size. Thus, different uses can be served with a flexible number of fuel cell systems.

Further, in a fuel cell system, the invention can provide that, when viewed in a stacking direction of the fuel cell system, a preferably trapezoidal storage space (or geometrically speaking, a straight cylinder having a trapezoidal bottom surface) is configured in order to arrange at least one functional component of the fuel cell system. It is conceivable that the at least one functional component of the fuel cell system can comprise an omnibus bar, an electrical plug, a compressor, a turbine, a humidifier, a fuel tank, a pump, a water tank, a coolant tank, and/or a control unit. Thus, a space-saving design of the fuel cell system can be enabled.

Furthermore, in a fuel cell system, the invention can provide that storage space is configured so as to receive a bearing structure of a current collector, in particular a bearing structure of a vehicle, preferably in a form-locking manner and/or in a friction-locking manner. In this way, the fuel cell system can be arranged simply and with little effort in the vehicle in order to, for example, serve as an energy supplier for at least one consumer, preferably for an electric motor, of the vehicle.

According to the fourth aspect, the present invention provides: a vehicle, in particular a hydrogen-powered vehicle, having at least one fuel cell system, which can be configured as described above. Using the vehicle according to the invention, the same advantages can be achieved as described above in connection with the method according to the invention and/or with the fuel cell system according to the invention. In the present case, reference to these advantages is made in full.

### BRIEF DESCRIPTION OF THE DRAWINGS

The invention and its further developments, as well as its advantages, will be explained in further detail below with reference to drawings. The drawings schematically show:

FIG. 1 Examples of known designs for cutting a band-shaped membrane material into individual membrane electrode assemblies,

FIG. 2 a schematic view of a known fuel cell having a rectangular membrane electrode assembly,

FIG. 3 a schematic view of a method according to the invention,

FIG. 4 a schematic view of a fuel cell system according to the invention, and

FIG. 5 a schematic view of a fuel cell system according to the invention.

In the various figures, like parts of the invention are always given the same reference numerals, for which reason they are usually only described once.

### DETAILED DESCRIPTION

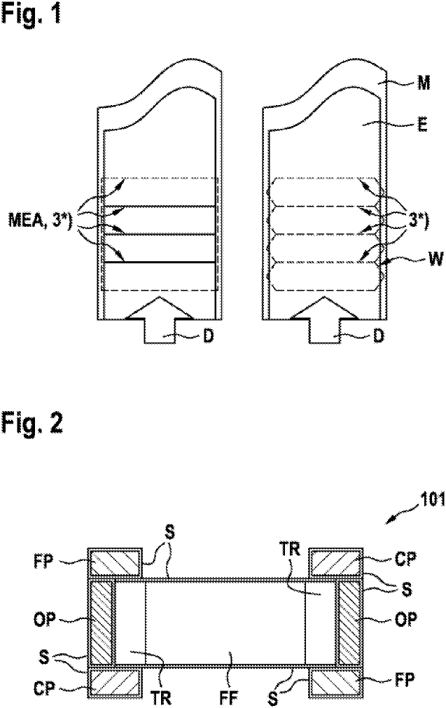

FIGS. 1 and 2 show known geometries for cutting a band-shaped membrane material M into individual membrane electrode assemblies MEA. The membrane material M is often coated with an active material E, a so-called catalyst layer, and optionally a gas diffusion layer (not shown).

The active material E serves to form an active surface of the membrane electrode assemblies MEA. In the modern fuel cells 101, the edge regions of the membrane material M that serve for media distribution are also often provided with the active material E, so that these edge regions can also serve for power generation.

In order to cut the membrane electrode assemblies MEA as much as possible without waste on the expensive active material E, the membrane electrode assemblies MEA can be cut in rectangular shapes, for example, as shown on the left in FIG. 1. However, this could result in the region around the membrane electrode assemblies MEA not being optimally exploited. As indicated in FIG. 2, regions can arise on the longitudinal sides of the membrane electrode assemblies MEA within a fuel cell 101 that cannot be fully exploited.

On the right hand side of FIG. 1 are shown membrane electrode assemblies MEA, which are made, for example, with triangular edge portions TR. Using the triangular edge portions TR, an attempt is made to find a compromise in order to provide edge regions with a power generation function and a fuel cell with a compact design. However, as can be seen from FIG. 1, waste with an expensive active material E is produced.

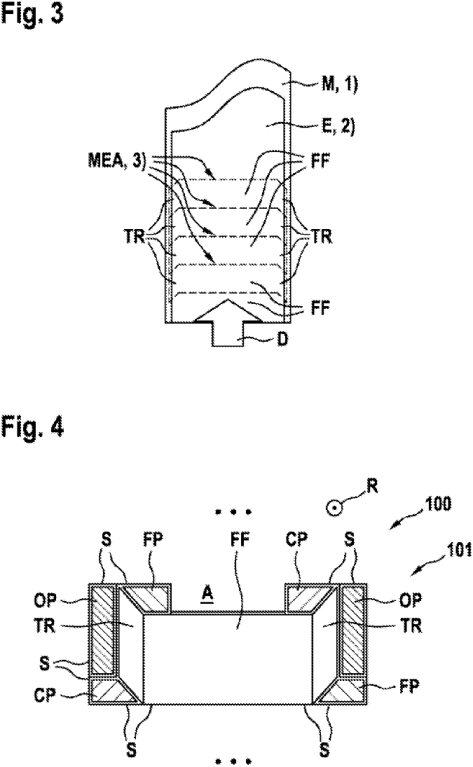

The invention is explained using FIGS. 3 to 5.

FIG. 3 serves to illustrate a method according to the invention for producing membrane electrode assemblies MEA for fuel cells 101, in particular in a continuous flow path process. The method comprises the following steps:
1) providing a band-shaped membrane material M in a flow path direction D, e.g. on a roller, such that in particular the membrane material can be unwound from the roller in the flow path process,
2) coating the band-shaped membrane material with an active material and a gas diffusion layer, if applicable (not shown),
3) cutting the coated membrane material M into individual membrane electrode assemblies MEA such that the individual membrane electrode assemblies MEA are formed with at least one edge region TR which is curved and/or angled when viewed in the flow path direction D.

According to the invention, in step 3), blanks of the coated membrane material M are provided with such edge portions TR that are curved or angled by the active surface FF of the individual membrane electrode assemblies MEA. FIGS. 2 to 5 show the edge portions TR substantially in the form of angular strips on the edge sides of the active surfaces FF of the individual membrane electrode assemblies MEA. In principle, however, it is also possible in the context of the invention that the edge portions TR can be provided in the form of curved or bent strips.

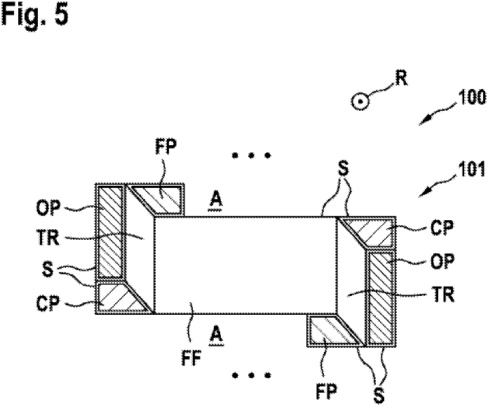

Using the invention, at least two significant advantages can be achieved:
the blanks can be produced sequentially without gaps on the band-shaped membrane material M such that, after cutting the individual membrane electrode assemblies MEA, there is almost no waste from the expensive active material E, and
only one (FIG. 4) or two (FIG. 5) narrow, for example trapezoidal (FIG. 4) or rectangular (FIG. 5), strips of an unused volume are produced on a longitudinal side or on both longitudinal sides of the individual membrane electrode assemblies MEA.

Stacking individual fuel cells 101 into a fuel cell system 100 according to FIG. 4 can create a trapezoidal storage space A (or, geometrically speaking, a straight cylinder with a trapezoidal bottom surface) in which all of the fuel cell system 100 devices and connectors can be space-savingly arranged, such as omnibus bars, electrical plugs, compressors, turbines, humidifiers, fuel tanks, pumps, water tanks, coolant tanks, and/or at least one control unit. Thus, because these functional components are needed in the fuel cell system 100 anyway, the overall space efficiency in the fuel cell system 100 can be increased. As a result, a compact rectangular housing can also be used in order to receive the fuel cell system 100, which is not shown in the figures merely for the sake of simplicity.

As shown in FIG. 3, the edge regions TR serving for media distribution can be coated nearly entirely with the active material E, wherein the individual membrane electrode assemblies MEA can be cut nearly 100% without waste from the coated membrane material M.

At the same time, FIGS. 4 and 5 indicate that the packaging capabilities of the fuel cell system 100 can be increased in an advantageous manner.

As further shown in FIGS. 3 to 5, in step 3) the individual membrane electrode assemblies MEA can have edge regions TR on both narrow sides, which are curved and/or angled when viewed in the flow path direction D. In principle, however, it is also possible that only one edge region TR can be curved and/or angled when viewed in the direction of the flow path D.

As shown in FIG. 4, the two edge regions TR can be formed so as to be curved and/or angled in the same direction. This can result in improved space saving in the fuel cell system 100.

As shown in FIG. 5, the two edge regions TR can be formed so as to be curved and/or angled in opposite directions. This can result in an improved stress profile in the fuel cell system 100.

As further indicated in FIGS. 3 to 5, the two edge regions TR can be symmetrical. In this way, the production and handling of the individual membrane electrode assemblies MEA can be simplified.

Correspondingly produced membrane electrode assemblies MEA for fuel cells 101 also constitute an aspect of the invention.

Also, a fuel cell system 100 having a plurality of fuel cells 101 each comprising such a membrane electrode assembly MEA constitutes an aspect of the invention.

Advantageously, a fuel cell system 100 according to the invention can be accommodated in a rectangular housing 102 in a space-saving manner.

As also suggested in FIGS. 4 and 5 and mentioned above in connection with the method according to the invention, a trapezoidal storage space A or two rectangular storage spaces form(s) in a stacking direction R of the fuel cell system 100 when viewed in order to arrange functional components of the fuel cell system 100.

Furthermore, it can be advantageous in the context of the invention when the storage space A or at least one of the two storage spaces A can be configured not only to accommodate functional components of the fuel cell system 100, but additionally or instead to accommodate a bearing structure of a current collector, in particular a bearing structure of a vehicle, for example in a form-locking and/or power-locking manner. In this way, the fuel cell system 100 according to the invention can be mounted particularly simply and elegantly on the supporting structure of the current collector, for example within the vehicle.

A corresponding vehicle having at least one or more modularly assembled fuel cell system(s) 100, which can be embodied as described above, also constitutes an aspect of the invention. The vehicle as a whole is not shown in the figures merely for the sake of simplicity.

The foregoing description of the figures describes the present invention solely in the context of examples. Of course, individual features of the embodiments can be freely combined with one another, insofar as technically sensible, without leaving the scope of the invention.

1. A method of producing membrane electrode assemblies (MEA) for fuel cells (101), the method comprising the following steps:
1) providing a band-shaped membrane material (M) in a flow path direction (D),
2) coating the band-shaped membrane material (M) with an active material (E), and
3) cutting the coated membrane material (M) into individual membrane electrode assemblies (MEA) such that the individual membrane electrode assemblies (MEA) are formed with at least one edge region (TR), which is curved and/or angled when viewed in the flow path direction (D).

2. The method according to claim 1, wherein in step 3), the individual membrane electrode assemblies (MEA) are formed with two edge regions (TR), which are curved and/or angled when viewed in the direction of the flow path (D).

3. The method according to claim 2, wherein the two edge regions (TR) are formed so as to be curved and/or angled in the same direction.

4. The method according to claim 2, wherein the two edge regions (TR) are formed so as to be curved and/or angled in opposite directions.

5. The method according to claim 2, wherein the two edge regions (TR) are formed so as to be symmetrical.

6. A method for producing a membrane electrode assembly (MEA) for a fuel cell (101), the method comprising the steps of claim 1.

7. A method for producing a fuel cell system (100) having at least one fuel cell (101) comprising a membrane electrode assembly (MEA), the method for producing a fuel cell system (100) including the method of claim 6.

8. The method according to claim 7, further comprising providing a rectangular housing (102) for the at least one fuel cell (101).

9. The method according to either of the claim 7, wherein when viewed in a stacking direction (R) of the fuel cell system (100), a storage space (A) is configured in order to arrange at least one functional component of the fuel cell system (100).

10. The method according to claim 9, wherein the storage space (A) is configured so as to receive a bearing structure of a current collector.

11. A method for producing a vehicle having at least one fuel cell system (100), the method for producing a vehicle including the method of claim 7.

12. The method according to claim 7, wherein when viewed in a stacking direction (R) of the fuel cell system (100), a trapezoidal storage space (A) is configured in order to arrange at least one functional component of the fuel cell system (100).

13. The method according to claim 9, wherein the storage space (A) is configured so as to receive a bearing structure of a vehicle.

14. The method according to claim 9, wherein the storage space (A) is configured so as to receive a bearing structure of a vehicle in a form-locking manner and/or in a friction-locking manner.
